(19) United States
(12) Patent Application Publication
(10) Pub. No.: US 2010/0203474 A1
(43) Pub. Date: Aug. 12, 2010

(54) DENTAL INSTRUMENT FOR LIFTING SINUS MEMBRANE AND APPLYING BONE POWDER

(76) Inventor: Chun-Leon CHEN, Changhua City (TW)

Correspondence Address: Guice Patents PLLC, 12647 Galveston Court #302, Manassas, VA, 20112, US

(21) Appl. No.: 12/366,815

(22) Filed: Feb. 6, 2009

(51) Int. Cl. A61C 3/00

(52) U.S. Cl. 433/163; 433/141

(57) ABSTRACT

A dental instrument includes an elongated handle configured for the grasping of a user's hand, a narrow elongated sinus membrane lifting tip extended from one end of the handle and having a smoothly curved end portion for insertion into the nasal sinus of a person to lift the sinus membrane, and a L-shaped bone powder applicator tip extended from the other end of the handle and having a peripherally grooved end portion for picking up bone powder for application to the inside of the nasal sinus.

### BACKGROUND OF THE INVENTION

1. Field of the Invention:

The present invention relates to dental equipment and more particularly, to a dental instrument for lifting a sinus membrane and applying bone powder to the nasal sinus.

2. Description of the Related Art:

The inventor of the present invention disclosed a quick dental implant implantation operation for allowing quick implantation of a dental implant. To facilitate performance of this quick dental implant implantation operation, the inventor created a number of dental instruments including, U.S. application Ser. No. 12/357,046, entitled “Improved implant root for tooth implanting”; U.S. application Ser. No. 12/265,854, entitled “Drill for rapid dental implant”; Taiwan Utility M313502, entitled “Adjustable double blade handle unit; Taiwan Utility M313504, entitled “Hydraulic pressure type nasal sinus membrane separator”; U.S. application Ser. No. 12/265,012, entitled “Vibrational filling device implanting tooth bone powder”; Taiwan Utility M313506, entitled “Tool set for raising height of nasal sinus”.

During a quick dental implant implantation operation, sinus lift treatment is an important technique, which is to make a hole on the cortical bone and the sinus and to extend the hole to the bottom side of the sinus membrane. Further, in the related prior art designs of “Hydraulic pressure type nasal sinus membrane separator” of M313504 and “Tool set for raising height of nasal sinus” of M313506, a hydraulic sinus membrane separator is disclosed for use to separate the sinus membrane.

However, the aforesaid hydraulic sinus membrane separator is simply for use to separate the sinus membrane from the cortical bone. When applying bone powder to the inside of the nasal sinus, a bone powder applicator must be used.

### SUMMARY OF THE INVENTION

The present invention has been accomplished under the circumstances in view. It is one object of the present invention to provide a dental applicator, which is practical for use to substitute for the hydraulic sinus membrane separator of a conventional sinus lift kit, facilitating quick sinus lift treatment and dental implantation.

To achieve this and other objects of the present invention, a dental instrument comprises an elongated handle configured for the grasping of a user's hand, a narrow elongated sinus membrane lifting tip extended from one end of the handle and having a smoothly curved end portion for insertion into the nasal sinus of a person to lift the sinus membrane, and a L-shaped bone powder applicator tip extended from the other end of the handle and having a peripherally grooved end portion for picking up bone powder for application to the inside of the nasal sinus.

### BRIEF DESCRIPTION OF THE DRAWINGS

FIG. 1 is a perspective view of a dental instrument.

FIG. 2 is a continuous series of drawings, showing application of the dental instrument in a sinus-lift treatment according to the present invention.

FIG. 3 is a schematic drawing showing the sinus membrane lifted and filled with bone powder, and an implant installed in the sinus according to the present invention.

### DETAILED DESCRIPTION OF THE PREFERRED EMBODIMENT

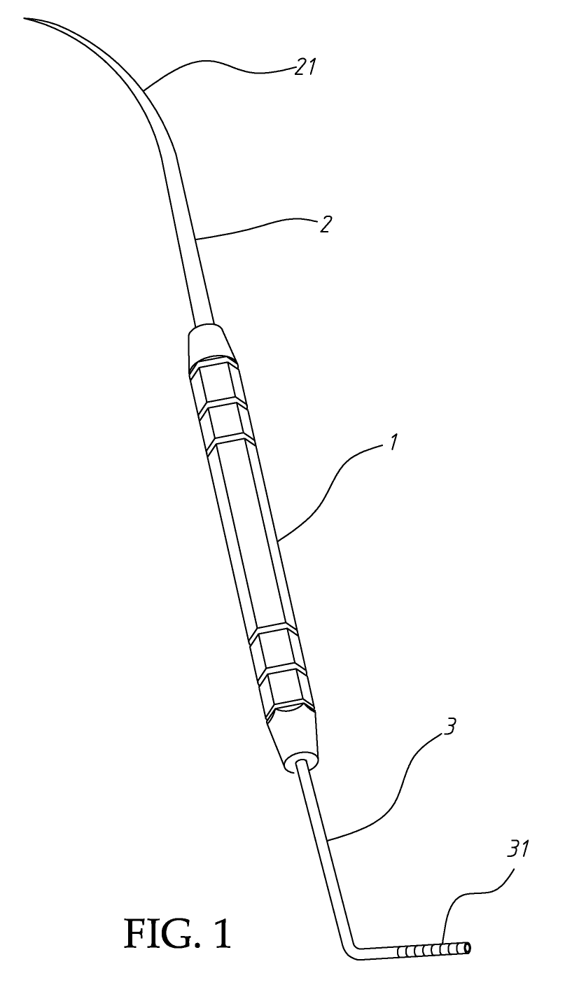

Referring to FIG. 1, a dental instrument for lifting sinus membrane and applying bone powder in accordance with the present invention is shown comprising a handle 1, a sinus membrane lifting tip 2, and a bone powder applicator tip 3.

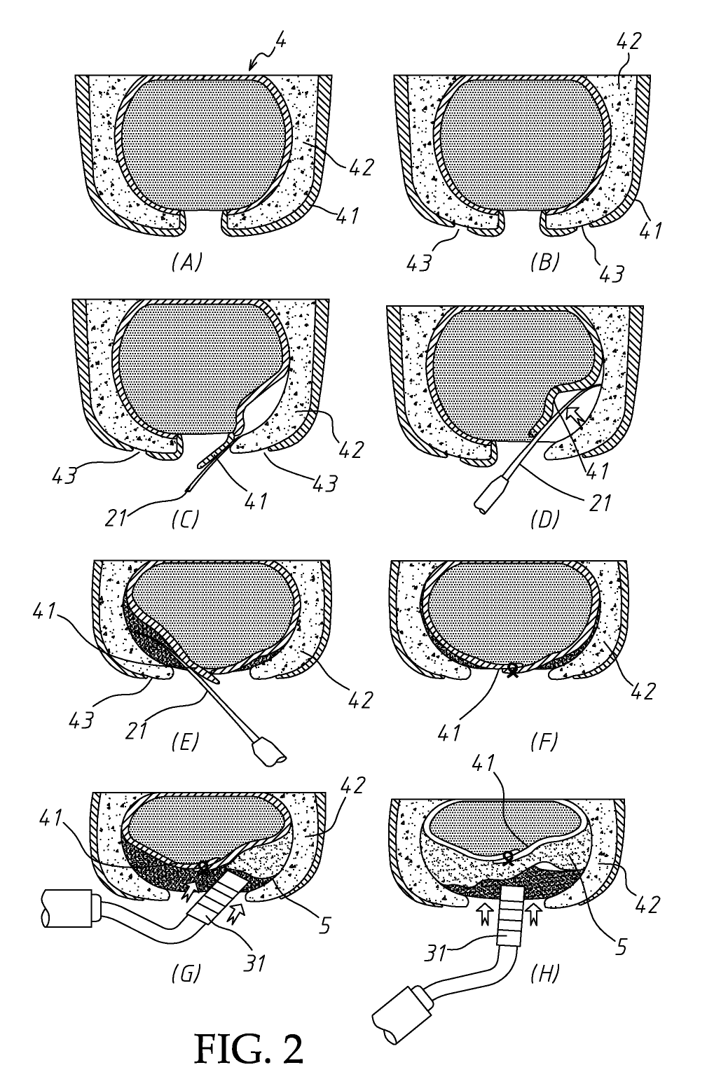

The handle 1 is a rod member configured for the grasping of a dentist with one hand. The sinus membrane lifting tip 2 is a narrow elongated member extended from one end of the handle 1, having a diameter about 2 mm and a smoothly curved end portion 21 suitable for insertion into the nasal sinus 4 to lift the sinus membrane 41 (see FIG. 2). The bone powder applicator tip 3 is an substantially L-shaped rod member extended from the other end of the handle 1, having a peripherally grooved end portion 31 for picking up bone powder 5 for application to the inside of the nasal sinus 4 (see FIG. 2).

Further, the sinus membrane lifting tip 2 and the bone powder applicator tip 3 may be coated with a layer of titanium coating.

FIG. 2 illustrates a sinus operation before dental implant. FIG. 2(A) is a sectional view of the nasal sinus 4 before sinus operation where the cortical bone 42 of the sinus 4 is covered by a sinus membrane 41. FIG. 2(B) illustrates two cuts 43 were made on the bottom side of the sinus membrane 41 to facilitate performance of a sinus-lift treatment. FIG. 2(C) illustrates the smoothly curved end portion 21 of the sinus membrane lifting tip 2 inserted into the one cut 43 to separate one part of the sinus membrane 41 from the cortical bone 42 of the nasal sinus 4. FIG. 2(D) illustrates the smoothly curved end portion 21 of the sinus membrane lifting tip 2 inserted into the one cut 43 further to lift the sinus membrane 41. FIG. 2(E) illustrates the smoothly curved end portion 21 of the sinus membrane lifting tip 2 inserted into the other cut 43 to separate the other part of the sinus membrane 41 from the cortical bone 42 of the nasal sinus 4 and to lift the sinus membrane 41. FIG. 2(F) illustrates the two lifted parts of the sinus membrane 41 stitched together. FIGS. 2(G) and (H) show the peripherally grooved end portion 31 of the bone powder applicator tip 3 used to pick up bone powder 5 and inserted into the space in the nasal sinus 4 to apply bone powder 5.

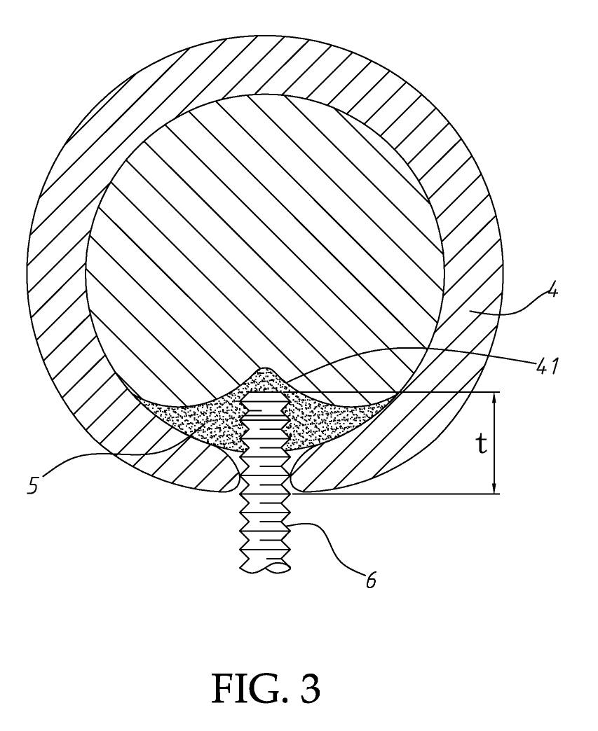

After filling of bone powder 5 in the space inside the nasal sinus 4, the prepared implant 6 is installed, as shown in FIG. 3. The space provided in the nasal sinus 4 allows insertion of the root of the implant 6 into a relatively deeper distance t, about 8mm, assuring high stability of the installed implant 6 for further installation of support and tooth crown.

The dental instrument for lifting sinus membrane and applying bone powder is practical for use to substitute for the hydraulic sinus membrane separator of a conventional sinus lift kit, facilitating quick sinus lift treatment and dental implantation.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A dental instrument for lifting a sinus membrane and applying bone powder to the nasal sinus, comprising:
an elongated handle configured for the grasping of a user's hand;
a narrow elongated sinus membrane lifting tip extended from one end of said handle, said narrow elongated sinus membrane lifting tip having a smoothly curved end portion for insertion into the nasal sinus of a person to lift the sinus membrane; and
a bone powder applicator tip being an substantially L-shaped rod member extended from an opposite end of said handle, said bone powder applicator tip comprising a peripherally grooved end portion for picking up bone powder for application to the inside of the nasal sinus.

2. The dental instrument as claimed in claim 1, wherein said narrow elongated sinus membrane lifting tip and said bone powder applicator tip are peripherally coated with a layer of titanium coating.

3. The dental instrument as claimed in claim 1, wherein narrow elongated sinus membrane lifting tip has a diameter of 2 mm.
